(19) United States
(12) Patent Application Publication
(10) Pub. No.: US 2015/0172975 A1
(43) Pub. Date: Jun. 18, 2015

(54) Controlling Node and Method for Maintaining a Neighbor Cell List

(71) Applicants: Elisabeth Hansson, Linkoping (SE); Tobias Ahlström, Ljungsbro (SE); Stefan Engström, Linkoping (SE); Johan Moe, Mantorp (SE)

(72) Inventors: Elisabeth Hansson, Linkoping (SE); Tobias Ahlström, Ljungsbro (SE); Stefan Engström, Linkoping (SE); Johan Moe, Mantorp (SE)

(73) Assignee: Telefonaktiebolaget L M Ericsson (publ), STOCKHOLM (SE)

(21) Appl. No.: 14/401,016

(22) PCT Filed: Jun. 7, 2012
(86) PCT No.: PCT/SE2012/050612

§ 371 Date: Nov. 13, 2014

(51) Int. Cl. H04W 36/00

(52) U.S. Cl. CPC H04W 36/0088

(57) ABSTRACT

A controlling node (225) for a first cell (227) in a cellular network (200), arranged to receive measurement reports from User Equipments, UEs (230, 255), in the first cell (227) on the signal strength and/or signal quality of transmissions from the controlling nodes of neighboring cells (217), and to maintain a list of neighboring cells based on such measurement reports. The list shows how many of the UEs (230, 255) in the first cell (227) that each of said neighboring cell's (217) controlling node “covers”, i.e. reaches with a signal strength and/or signal quality above a certain level. The controlling node is also arranged to decide to perform blind handover or release with redirect on one of the UEs in the first cell, and to choose one or more of the cells in the list as the target cell or cells for blind handover or release with redirect.

### TECHNICAL FIELD

The present invention discloses a controlling node and a method for mobility in a cellular system.

### BACKGROUND

In cellular systems such as, for example, LTE and GSM systems, mobility of User Equipments, UEs, in the sense of transferring the control of the UEs between the controlling nodes of different cells in the cellular system is performed under the control of the cellular system, usually based on measurements of the cell that the UE is in at the moment as well as measurements on the cells that surround the UE's present cell. Such UE mobility is usually referred to with the general term “handover”.

A UE transmits reports to its controlling node, i.e. the controlling node of the cell that the UE is in at the moment, with the reports comprising the signal strength that the UE has measured from its own cell as well as from neighboring cells, and based on these reports the cellular system decides if the UE should be handed over to a neighboring cell or not. (The measurements are, to be more specific, made on the strength of signals received by the UE from the controlling node of the UE's own cell and of its neighboring cells, although this is here, in the interest of brevity, referred to as merely being measurements on the UE's own and neighboring cells.)

As an alternative to measuring signal strength, the UE may measure and report the signal quality of the own and neighboring cells. In this case, the decision on handover can be based on the signal quality reports instead of signal strength reports. The measurements and reports may also include both signal strength and signal quality, in which case the handover decisions are based on a combination of signal strength and signal quality.

Thus, in most cases, handover of a UE is based on measurement reports from the UE to the cellular system via its controlling node. However, there are also handover procedures which are not based on such measurement reports, among them so called “blind handover” and “release with redirect with target cell information”, the latter case here in the interest of brevity also sometimes being referred to merely as “release with redirect”. Another term which is sometimes also used for “release with redirect” is “mobility without preparation in the target node”.

In the case of blind handover, a UE is handed over to another cell without any measurements having been made by the UE on that cell, at least not for a certain period of time. However, resources are prepared for the UE in the target cell, i.e. the target cell is notified of the impending handover. Blind handover is, for example, used when the cellular system knows that the target cell fully covers the source cell.

In the case of release with redirect, a UE is transferred to a target cell without any preparations having been made in the target cell. Examples of release with redirect include RRC Connection Release with redirection to a given carrier frequency and RRC Connection Release with redirection with system information for a target cell.

Blind handover and release with redirect currently require manual handling in order to select the target cells, i.e. the UE's new cells, due to the lack of measurements and/or preparations.

### SUMMARY

It is an object of the invention to obviate at least some of the difficulties involved in blind handover and unprepared mobility. This object is obtained by means of a controlling node for a first cell in a cellular network.

The controlling node is arranged to receive measurement reports from User Equipments, UEs, in the first cell on the signal strength and/or signal quality of transmissions from the controlling nodes of neighboring cells at said UEs, and to maintain a list of neighboring cells based on such measurement reports.

The list shows how many of the UEs in the first cell that each of said neighboring cell's controlling node “covers”, i.e. reaches with a signal strength and/or signal quality above a certain level.

The controlling node is also arranged to decide to perform blind handover or release with redirect of one of the UEs in the first cell, and to choose one or more of the cells in the list as the target cell or cells for blind handover or release with redirect

The list mentioned above can be seen as a list of the “relevance” of neighboring cells, where relevance is seen as the number or percentage of the UEs in the “own” cell that each of the neighboring cell's controlling node “covers”, i.e. reaches with a signal strength and/or quality above a certain level. Using this information on relevance, a controlling node can decide to perform blind handover or release with redirect to a target cell or cells that the controlling node knows has a high degree of relevance and which thus is/are good candidates for the blind handover or release with redirect. The list is maintained by the controlling node, but can be established either by the controlling node or be received by the controlling node from another node in the cellular system.

In embodiments, the controlling node is arranged to, if it decides to perform release with redirect of one of the UEs in the first cell, to transmit information on said one or more of the cells in the list to the UE.

In embodiments of the controlling node, the list also comprises system information for the neighboring cells.

In embodiments of the controlling node, the list is per frequency or frequency group.

In embodiments, the controlling node is arranged to instruct all or a sub-set of the UEs in the first cell to transmit said measurement reports to the controlling node.

In embodiments, in the case of a sub-set, the controlling node is arranged to choose the UEs in the sub-set in a random fashion.

In embodiments, the controlling node is arranged to establish the list based on said measurement reports, and in the case of a sub-set, the controlling node is arranged to use the measurement reports to extrapolate how many of the UEs in the first cell that each of said neighboring cells covers, expressed as a percentage.

In embodiments, the controlling node is arranged to transmit the measurement reports to another node in the cellular system, and to receive the list from another node in the cellular system.

In embodiments, the controlling node is arranged to, in the case of release with redirect, transmit instructions to the UE to perform release with redirect to one of the cells in said list without notifying the controlling nodes of the cells in said list that the UE has been instructed to perform release with redirect.

In embodiments, the controlling node is arranged to, in the case of blind handover, transmit instructions to the UE to perform handover, the controlling node being arranged to notify the controlling node of said neighboring cell that the UE has been instructed to perform handover.

In embodiments, the controlling node is arranged to establish the list so that it contains a predetermined number N of neighboring cells, which are the N neighboring cells that have the highest degree of coverage in the first cell.

In embodiments, the controlling node is arranged to transmit the list to another controlling node in the cellular network, either via a direct interface to the other controlling node or via an intermediary node in the cellular network. Examples of such intermediary nodes comprise, using terminology from different kinds of cellular systems, Mobility Management Entities, Base Station Controllers, Radio Network Controllers, switches, routers, etc.

In embodiments, the controlling node is arranged to receive from another controlling node, directly or via another network node in the cellular network, a corresponding list established by the other controlling node for a cell controlled by the other controlling node. The controlling node is arranged to use the corresponding list when making decisions on blind handover or release with redirect for UEs in its cell.

In embodiments, the controlling node is also arranged to receive measurement reports from UEs in the first cell on the signal strength and/or quality of specific frequencies from controlling nodes of neighboring cells at the UEs, and to maintain a list of such frequencies, the list showing how many of the UEs in the first cell that each of said frequency “covers”, i.e. reaches with a signal strength and/or quality above a predetermined level. The controlling node is also arranged to transmit all or parts of this list to a UE in the first cell, as well as to instruct the UE to perform release with redirect to one of the frequencies in this list.

In addition, the invention comprises a method for use in a controlling node in a cellular system.

### BRIEF DESCRIPTION OF THE DRAWINGS

The invention will be described in more detail in the following, with reference to the appended drawings, in which

FIGS. 1 and 2 show parts of a cellular system, and

FIGS. 3 and 4 show tables of adjoining cell coverage in a cell in a cellular system, and

FIG. 5 shows an example of adjoining cell coverage, and

FIG. 6 shows a block diagram of a controlling node, and

FIG. 7 shows a flow chart of a method.

### DETAILED DESCRIPTION

Embodiments of the present invention will be described more fully hereinafter with reference to the accompanying drawings, in which embodiments of the invention are shown. The invention may, however, be embodied in many different forms and should not be construed as being limited to the embodiments set forth herein. Like numbers in the drawings refer to like elements throughout.

The terminology used herein is for the purpose of describing particular embodiments only, and is not intended to limit the invention.

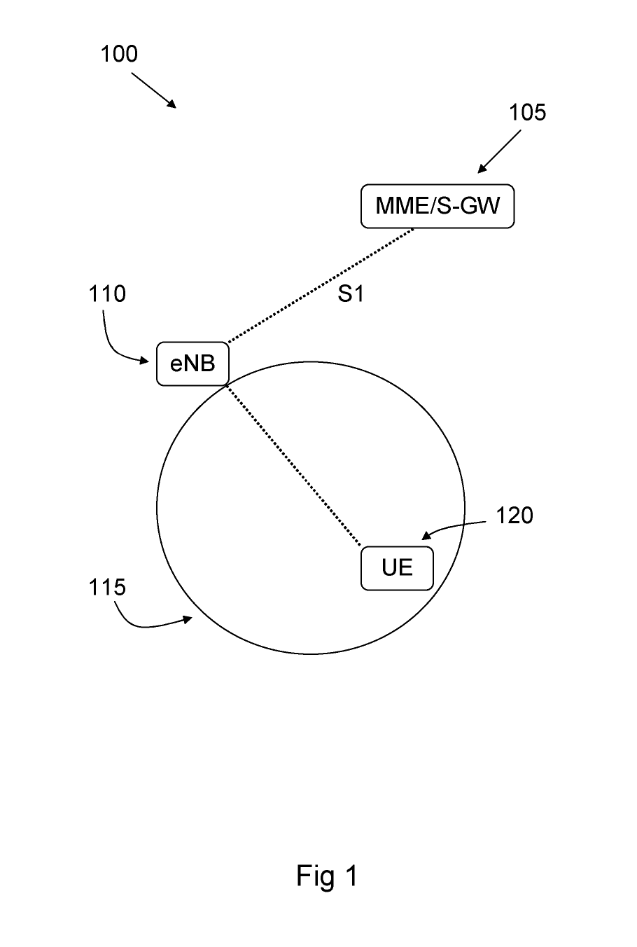

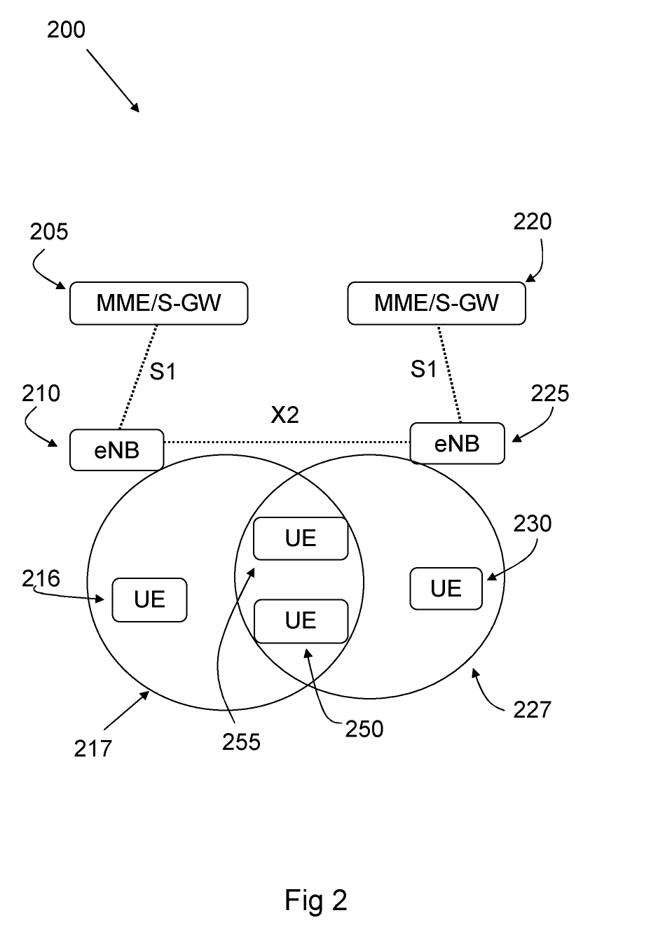

In order to facilitate the understanding of the invention, parts of a cellular system will first be described with reference to FIGS. 1 and 2. Terminology from the LTE system will be used, although it should be emphasized that this is only in order to facilitate the understanding of the invention, and is not intended to limit the scope of protection sought or gained for the invention. The invention can be applied in cellular systems such as, for example, GSM, although the terminology used may sometimes vary slightly from system to system.

FIG. 1 shows a cell 115 in an LTE system 100 which comprises a number of cells. Each cell in the LTE system 100 can accommodate a number of mobile devices, here referred to as User Equipments, UEs, one of which is shown as 120. All traffic to and from the UEs in a cell is routed via a controlling node 110 of the cell, in LTE known as the eNodeB or eNB. Such controlling nodes are also sometimes generically referred to as “Base Stations”. Control of the UEs in the cell 115 is carried out by the eNB 110 together with a node known as MME, Mobility Management Entity, shown as 105 in FIG. 1. The MME 105 is connected to the eNB 110 via the S1 interface. The system 100 also comprises an S-GW, Serving Gateway, which can either be co-located with the MME 105 or placed in a location of its own.

A UE such as the one 120 regularly performs measurements on the signal strength and/or quality of transmissions which are received from the controlling node 105 of its own cell 115, as well as measurements on the signal strength and/or quality of transmission which are received from the controlling nodes of other cells in the system 100, usually neighboring cells. The results of these measurements are transmitted to the eNB 110, which either processes these results on its own or transmits the results to the MME 105 for further processing. The processing is, inter alia, carried out in order to make decisions on handover.

FIG. 2 shows a slightly larger part of an LTE system 200. Here we see two neighboring cells 217, 227, each with its eNB 210, 225, interconnected by the X2 interface, and we also see the MMEs 205, 220 of the cells 217, 227, as well as the S-GWs described previously.

As is shown in FIG. 2, neighboring cells often “cover” all or parts of each other in the sense that the transmissions from the eNB of one cell often reach the UEs of one or more neighboring cells, at least with some degree of strength and/or quality. As mentioned, the UEs in a cell perform measurements on the strength and/or quality of signals received from a set of defined eNBs of other cells in the system, and then report the results of their measurements to the eNB of their cell for use in so called handover, i.e. when control of a UE is transferred from the eNB of one cell to the eNB of another cell, so that the UE is in effect moved from one cell to another. Due to the fact that one and the same physical eNB can be the eNB of more than one cell at a time, handover of a UE can actually be within one and the same physical eNB, or between two physically separate eNBs.

The inter-cell coverage in the system 200 is as follows: UE 230 is in cell 227, while UE 216 is in cell 217. UE 255 is in cell 227 but is also covered by cell 217, and UE 250 is in cell 217, but is also covered by cell 227.

Although the transfer of the control of a UE is usually performed within the framework of what is conventionally referred to as “handover”, i.e. the procedure described above with measurements on the signal strength and/or quality of adjoining cells, and transfer of the UE to the cell with the strongest signal, control of a UE can also be transferred to another cell in other procedures, one of which is known as “blind handover” and another of which is referred to as “release with redirect with target cell information”, this latter case also being referred to simply as “release with redirect”.

Blind handover is performed without any measurements (for a certain period of time) on the target cell by the UE, although resources are prepared in the target cell, i.e. the target cell is notified of the impending handover. If an eNB decides to perform blind handover of a UE to another cell, the UE and the target cell will not perceive this, i.e. it is only the “source eNB” that knows that the handover is in fact a blind handover.

Release with redirect is performed without preparations in the target cell, and comprises the following sub-cases:
RRC Connection Release with redirection without System Information
RRC Connection Release with redirection with System Information

Other mobility procedures which are similar to release with redirect and in which the invention can also prove useful include:
Cell change order without NACC (used for mobility between LTE and GSM systems).
Cell change order with NACC (used for mobility between LTE and GSM systems).

The cases of blind handover and release with redirect will now be described, with reference to the UE 255, the eNBs 225 and 210 and the cells 227 and 217, where the cell 227 is the “source cell” and the cell 217 is the “target cell”.

In order to facilitate blind handover and release with redirect, a controlling node such as the one 225 is arranged to maintain a list which shows how many of the UEs in its cell 227 that are also covered by one or more controlling nodes of another cell, i.e. that reach the UEs in the cell with a signal strength and/or quality above a certain level. The list is based on the measurement reports from the UEs in the cell 227 to the controlling node 225, and can be seen as a statistical measure of the degree of coverage that other cells have in the cell 227. This is useful when performing blind handover or release with redirect, since even if the UE on which blind handover or release with redirect is performed has not reported on a certain other cell, such as the neighbor cell 217, the list can still be seen as a good representation of which cell or cells that are good candidates for blind handover or release with redirect.

When, for one of a variety of reasons, the eNB 225 or the MME 220 decides to perform blind handover or release with redirect of the UE 255, the eNB 225 transmits all or parts of the list mentioned above to the UE 255, along either with instructions to perform blind handover or with instructions to perform release with redirect. Examples of cases when blind handover is initiated include cases when a UE has poor coverage from its own eNB and/or has poor measurement capabilities.

In the case of blind handover, the eNB 225 chooses one of the cells in the list, e.g. the cell 217, as the target cell for the blind handover, and will retrieve the information necessary to perform the blind handover from the target cell's eNB, usually via the X2 interface, but possibly also via the S1 interface.

In the case of release with redirect, the eNB either transmits the entire list or only a part of the list, said part comprising the N (integer) cells that have the highest degree of coverage in the source cell, i.e. the neighbor cell 217 in this example. The coverage can be expressed as a percentage of how many of the UEs in the cell 227 that are covered by each cell in the list. If more than one cell s included in the list, the UE is free to choose one of the cells, which will usually be the cell with the strongest signal or the best signal quality, or a combination of those.

In the case of blind handover, the controlling node of the target cell is notified by the controlling node of the source cell, i.e. the eNB 225, of the impending handover (note, only of the impending handover“, not of the impending blind handover”, since it is only the source eNB which knows that the handover is in fact a blind handover) so that resources can be prepared in the target cell. Thus, in the example with the cell 217 as the target cell, the eNB 210 is notified by the eNB 225 of the impending handover of the UE 255. The eNB 210 responds to the eNB 225 with information about the prepared resources and also with information about the target cell, which information shall be forwarded to the UE by eNB 225. The information from the eNB 210 to the eNB 225 either goes via the X2 or the S1 interface, or via a combination of these interfaces.

In the case of release with redirect, the controlling node of the target cell, in this example the eNB 210 of the cell 217, is not notified by the eNB 225 of the impending release with redirect of the UE 255.

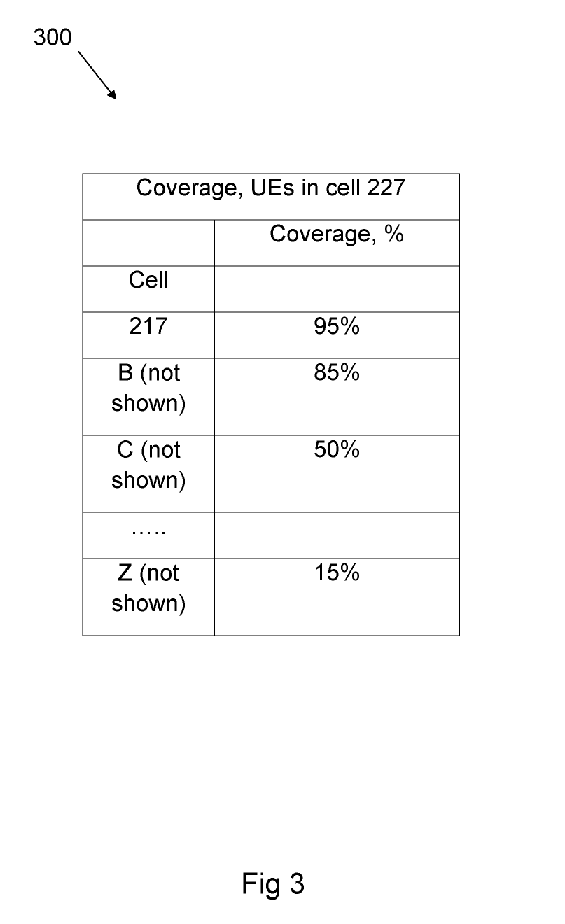

FIG. 3 shows an example 300 of a list 300 as described above and as maintained by the eNB 225. As shown in FIG. 3, the list 300 shows the cell identity of the “covering cells”, one of which is the cell 217 in FIG. 2, and the other cells being shown with the use of letters B-Z, but which in embodiments would be by means of a cell ID, global or specific to the system, which would also be the case for cell 217. The list 300 shows the coverage of each of a number of other cells, the coverage here being shown as a percentage, but which as mentioned, may also be the number of UEs in the cell which is covered by each of the cells in the list.

As has emerged from the description above, the list 300 is based on measurement reports from the UEs in a cell to their eNB. The eNB is arranged to instruct all or a sub-set of the UEs in its cell to transit these measurement reports to the eNB. In the case of a sub-set, the sub-set can be chosen by the eNB in, for example, a random manner from among the UEs in the cell.

The example 300 of a list shown in FIG. 3 comprises information on the identity of the cells in the list and their degree of coverage. In embodiments, the list also comprises system information for the cells in the list. Examples of system information include information on the cell properties and its configuration, e.g. the cell's PLMN, Cell ID etc.

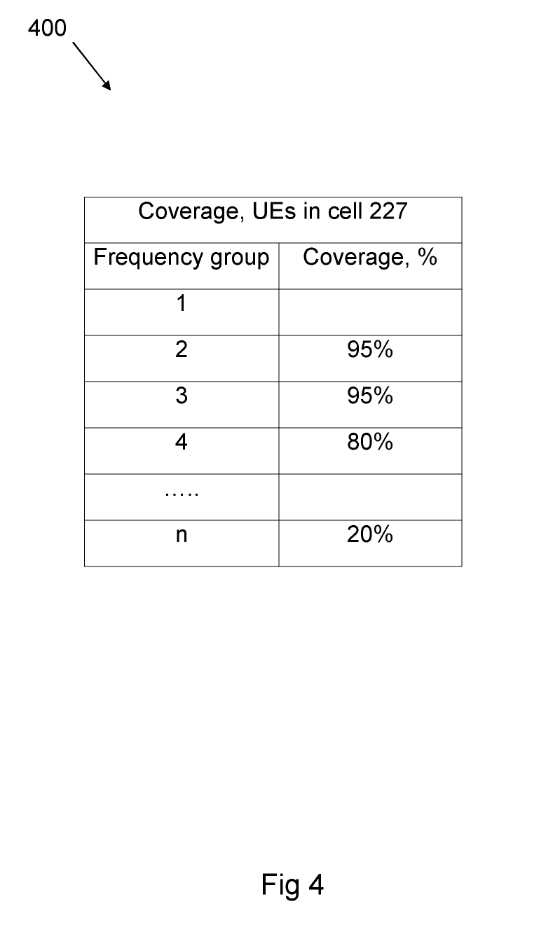

In addition, the list is also, in embodiments, arranged per frequency or per frequency group. An example of such a list 400 is shown in FIG. 4, which shows the coverage in the cell 227 of neighboring cells in frequency groups, where the accumulated coverage of cells within one and the same frequency group is listed. The example explicitly shows four such frequency groups, and indicates the possibility of n (integer) such groups.

Returning now to the case of blind handover, the eNB 225 is arranged to perform blind handover of an UE from the cell 227 to another cell in the cellular system 200 in, for example, the following cases:

Blind handover is performed to cells whose degree of coverage in the cell in which the UE is in at present is over a certain threshold. If the threshold is set to 100% or close to it (e.g. 95-99%), this guarantees a high likelihood of successful blind handover.

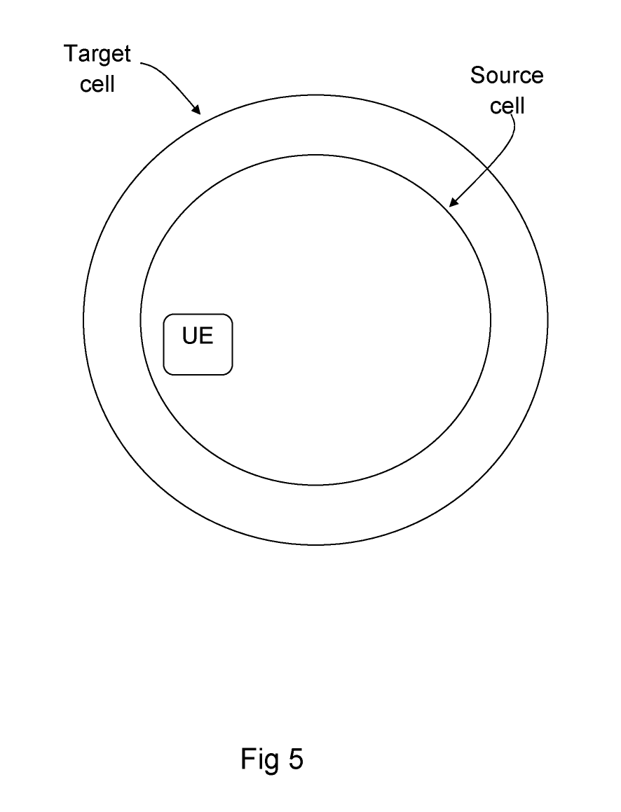

In embodiments, blind handover is performed to cells whose degree of coverage in the cell in which the UE is in at present is over a first threshold, and in which the UE's present cell has a coverage which is less than a second threshold. (The eNBs of two or more cells can report which coverage they have in each other's cell via, for example, the X2 interface.) Consider, for example, the case where the first threshold is 100% and the second threshold is less than 100%, e.g. 80%. This would indicate a situation like the one shown in FIG. 5, where the source cell is contained in the target cell, which ensures a high likelihood of successful blind handover.

Above, the verb “maintain” has been used to describe the eNB's relationship to a list such as the one 300. The verb “maintain” is used here to indicate that the list may be kept and updated in the eNB over a certain amount of time, or the list may be discarded or deleted, and the eNB starts to maintain a new list, immediately or after a certain period of time.

In embodiments, the eNB 225 is arranged to also establish the list on its own or with the aid of another node in the system, as follows:

In one embodiment, the eNB 225 is arranged to receive the measurement reports from the UEs in its cell, and to use them to establish the list. In such an embodiment, the eNB 225 compares the reported signal strength and/or quality of the cells with a certain threshold or level, and all cells that have a reported signal strength and/or quality above this are entered into the list, and for each such cell the eNB 225 determines how many of the UEs that have reported a signal strength and/or quality above the threshold or level for that cell. If, for example, all UEs report that a certain cell has a signal strength and/or quality above the threshold, the coverage value entered into the list for that cell will be 100%. The threshold for a cell to be entered into the list can also be combined with a condition of the reported cell to be the strongest cell on that particular frequency. This is to ensure that only the best cell on every frequency (in a certain location) is entered into the list.

In the case where the eNB 225 instructs only a sub-set of N (integer) UEs in the cell to transmit their measurement reports, the eNB is arranged to use the N measurement reports to extrapolate how many of the UEs in the cell that each reported cell covers, expressed as a percentage or as an amount.

In another embodiment, the eNB 225 is arranged to transmit the measurement reports to another node in the system, which then establishes the list and sends it back to the eNB 225 which then maintains the list. Examples of such other nodes include nodes in the cellular system's OaM (Operation and Maintenance) system. In the case of UTRAN/GSM systems, such nodes include a Radio Network Controller, RNC, and/or a Base Station Controller, BSC.

Naturally, the list may also be established in cooperation between two or more nodes in the cellular system 200.

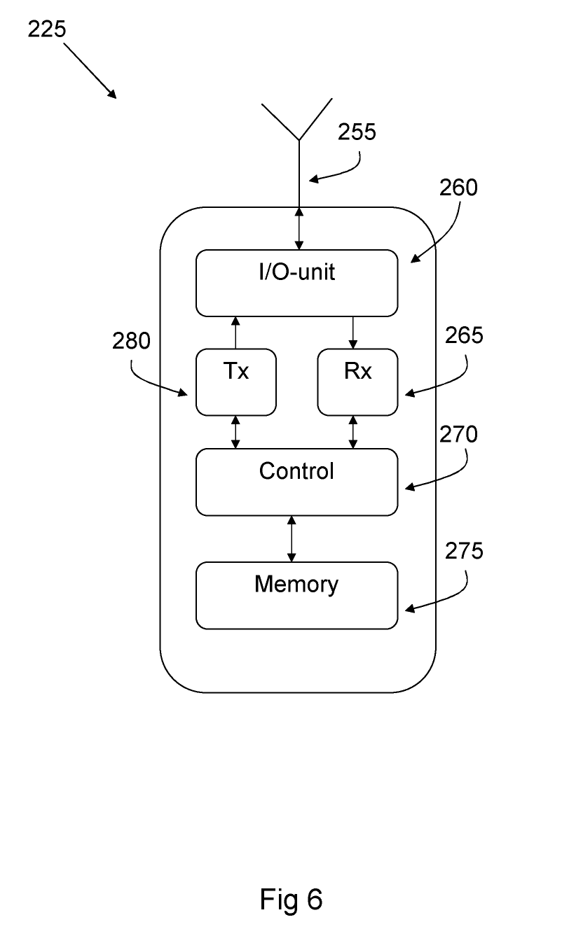

FIG. 6 shows a schematic block diagram of a controlling node 225. The controlling node 225 comprises an antenna unit 255, which is used for transmissions to and from the UEs in the cell or cells which the controlling node controls. In addition, the controlling node 225 also comprises an I/O unit 260 which is connected to the antenna unit 255 for processing transmissions to/from the controlling node 225.

In addition, the I/O-unit 260 also serves as an interface unit towards nodes in the system to which the controlling node is connected via other means than the antenna unit 255, e.g. connections via “landlines”.

As shown in FIG. 6, the controlling node comprises a transmit unit, Tx 280, which serves to, for example, in the case of transmissions via the antenna unit 255, modulate information and convert them to the proper transmission frequency. Similarly, the controlling node 225 also comprises a receive unit, Rx 265, which serves to, for example, in the case of transmissions via the antenna unit 255, demodulate information and convert them to lower frequencies or to baseband frequency.

In addition, there is also a control unit 270 arranged to control all or the main the functions of the controlling node 225. The list described above can, if it is established in the controlling node 225, be established by the control unit 270. In addition, the controlling node 225 also comprises a memory unit 275, connected to the control unit 270. The memory unit 275 can serve to, for example, be the unit in which the list described above is maintained.

The units 270 and 275 can be used in order to decide to perform blind handover or release with redirect of one of the UEs in the first cell, and to choose one or more of the cells in the list as the target cell or cells for blind handover or release with redirect.

Following a decision to decide to perform blind handover or release with redirect of one of the UEs in the first cell, the controlling node 225 transmits the corresponding instructions to the UE in question, suitably by means of the units 265, 260 and 255.

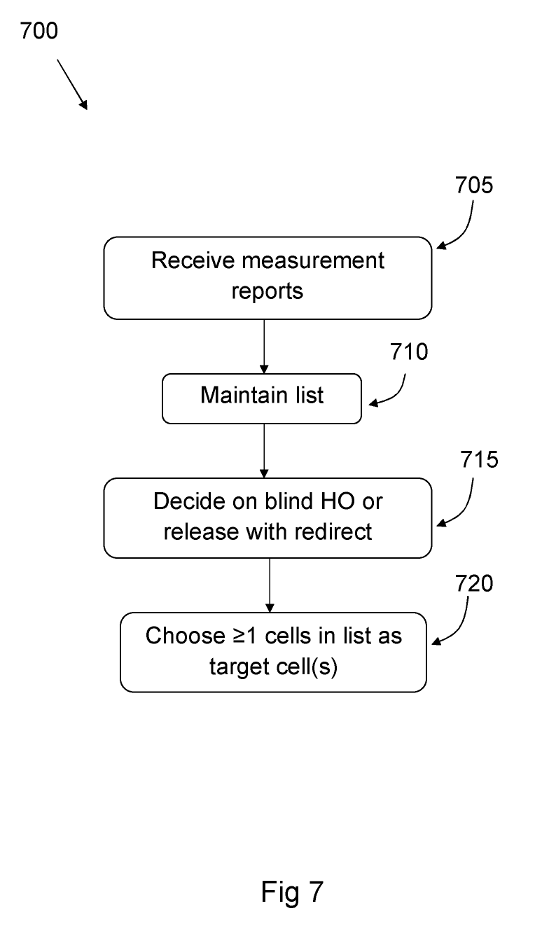

FIG. 7 shows a flow chart of a method 700 for use in a controlling node for a first cell in a cellular network. As shown in step 705, the method 700 comprising receiving measurement reports from User Equipments, UEs in said first cell on the signal strength and/or signal quality of transmissions from the controlling nodes of neighboring cells at said UEs.

As shown in step 710, the method 700 also comprises maintaining a list of neighboring cells based on such measurement reports, with the list showing how many of the UEs in the first cell that each of said neighboring cells “covers”, i.e. reaches with a signal strength and/or quality above a certain level.

As shown in step 715, the method further comprises deciding to perform blind handover or release with redirect of one of the UEs in the first cell, and, step 720, to choose one or more of the cells in the list as target cell or cells for the blind handover or the release with redirect.

In embodiments of the method 700, in the case of a decision to perform release with redirect of one of the UEs in the first cell, information on said one or more cells in the list is transmitted to the UE.

In embodiments of the method 700, said list also comprises system information for the neighboring cells.

In embodiments of the method 700, said list is per frequency or frequency group.

In embodiments, the method 700 comprises instructing all or a sub-set of the UEs in the first cell to transmit said measurement reports to the controlling node. In embodiments, the method 700 comprises, in the case of a sub-set, choosing the UEs in the sub-set in a random fashion.

In embodiments, the method 700 comprises establishing said list based on said measurement reports, and in the case of a sub-set, using the measurement reports to extrapolate how many of the UEs in the first cell that each of said neighboring cells covers, expressed as a percentage.

In embodiments, the method 700 comprises transmitting said measurement reports to another node in the cellular system, and receiving said list from another node in the cellular system.

In embodiments, in the case of release with redirect, the method 700 comprises transmitting instructions to the UE to perform release with redirect to one of the cells in said list without notifying the controlling nodes of the cells in said list that the UE has been instructed to perform release with redirect.

In embodiments, in the case of blind handover, the method 700 comprises transmitting instructions to perform handover to the UE and notifying the controlling node of said neighboring cell that the UE has been instructed to perform handover.

In embodiments, the method 700 comprises establishing said list so that it contains a predetermined number N of neighboring cells, which are the N neighboring cells that have the highest degree of coverage in the first cell.

In embodiments, the method 700 comprises transmitting said list to another controlling node in the cellular network, either via a direct interface to the other controlling node, or via an intermediary node in the cellular network.

In embodiments, the method 700 comprises receiving from another controlling node, directly or via another network node in the cellular network a corresponding list established by the other controlling node for a cell controlled by the other controlling node. The method comprises the use of said corresponding list when making decisions for UEs in its cell on blind handover or release with redirect.

In embodiments, the method 700 comprises receiving measurement reports from User Equipments, UEs, in the first cell on the signal strength and/or quality of specific frequencies from controlling nodes of neighboring cells at said UEs, and maintaining a list of such frequencies based on measurement reports, said list showing how many of the UEs in the first cell that each of said frequency “covers”, i.e. reaches with a signal strength and/or quality above a predetermined level, the method also comprising transmitting all or parts of said list to a UE in the first cell, as well as instructing the UE to perform release with redirect to one of the frequencies in said list.

Again, as has also been pointed out previously in this text, the measurement reports from a UE in a cell is based on measurements on the received signal strength and/or quality of transmissions from the controlling node of its own cell or the controlling nodes of other cells. However, in the text above, in the interest of brevity, this is sometimes merely referred to as “measurements on the cell”.

Similarly, blind handover or release with redirect is performed to the controlling node of another cell, not to the cell as such, although, sometimes, again in the interest of brevity, this is merely referred to above as being to another cell.

Embodiments of the invention are described with reference to the drawings, such as block diagrams and/or flowcharts. It is understood that several blocks of the block diagrams and/or flowchart illustrations, and combinations of blocks in the block diagrams and/or flowchart illustrations, can be implemented by computer program instructions. Such computer program instructions may be provided to a processor of a general purpose computer, a special purpose computer and/or other programmable data processing apparatus to produce a machine, such that the instructions, which execute via the processor of the computer and/or other programmable data processing apparatus, create means for implementing the functions/acts specified in the block diagrams and/or flowchart block or blocks.

In some implementations, the functions or steps noted in the blocks may occur out of the order noted in the operational illustrations. For example, two blocks shown in succession may in fact be executed substantially concurrently or the blocks may sometimes be executed in the reverse order, depending upon the functionality/acts involved.

In the drawings and specification, there have been disclosed exemplary embodiments of the invention. However, many variations and modifications can be made to these embodiments without substantially departing from the principles of the present invention. Accordingly, although specific terms are employed, they are used in a generic and descriptive sense only and not for purposes of limitation.

The invention is not limited to the examples of embodiments described above and shown in the drawings, but may be freely varied within the scope of the appended claims.

1. A controlling node for a first cell in a cellular network, the controlling node being arranged to receive measurement reports from User Equipments, UEs, in the first cell on the signal strength and/or signal quality of transmissions from the controlling nodes of neighboring cells at said UEs, and to maintain a list of neighboring cells based on such measurement reports, said list showing how many of the UEs in the first cell that each of said neighboring cell's controlling node “covers”, i.e. reaches with a signal strength and/or signal quality above a certain level, the controlling node also being arranged to decide to perform blind handover or release with redirect of one of the UEs in the first cell, and to choose one or more of the cells in the list as the target cell or cells for blind handover or release with redirect.

2. The controlling node of claim 1, arranged to, if it decides to perform release with redirect of one of the UEs in the first cell, to transmit information on said one or more of the cells in the list to the UE.

3. The controlling node of claim 1, in which said list also comprises system information for said neighboring cells.

4. The controlling node of claim 1, in which said list is per frequency or frequency group.

5. The controlling node of claim 1, being arranged to instruct all or a sub-set of the UEs in the first cell to transmit said measurement reports to the controlling node.

6. The controlling node of claim 4, which in the case of a sub-set is arranged to choose the UEs in the sub-set in a random fashion.

7. The controlling node of claim 1, being arranged to establish said list based on said measurement reports, and in the case of a sub-set, being arranged to use the measurement reports to extrapolate how many of the UEs in the first cell that each of said neighboring cells covers, expressed as a percentage.

8. (canceled)

9. The controlling node of claim 1, being arranged to, in the case of release with redirect, transmit instructions to the UE to perform release with redirect to one of the cells in said list without notifying the controlling nodes of the cells in said list that the UE has been instructed to perform release with redirect.

10. The controlling node of claim 1, being arranged to, in the case of blind handover, transmit instructions to the UE to perform handover, the controlling node being arranged to notify the controlling node of said neighboring cell that the UE has been instructed to perform handover.

11. The controlling node claim 1, being arranged to establish said list so that it contains a predetermined number N of neighboring cells, which are the N neighboring cells that have the highest degree of coverage in the first cell (227).

12. (canceled)

13. The controlling node of claim 1, being arranged to receive from another controlling node, directly or via another network node in the cellular network, a corresponding list established by the other controlling node for a cell controlled by the other controlling node, the controlling node being arranged to use said corresponding list when making decisions on blind handover or release with redirect for UEs in the first cell.

14. The controlling node of claim 1, also being arranged to receive measurement reports from User Equipments, UEs, in the first cell on the signal strength and/or quality of specific frequencies from controlling nodes of neighboring cells at said UEs, and to maintain a list of such frequencies based on measurement reports, said list showing how many of the UEs in the first cell that each of said frequency “covers”, i.e. reaches with a signal strength and/or quality above a certain level, the controlling node also being arranged to transmit all or parts of said list to a UE, in the first cell, as well as to instruct the UE to perform release with redirect to one of the frequencies in said list.

15. A method for use in a controlling node for a first cell in a cellular network, the method comprising receiving measurement reports from User Equipments, UEs in said first cell on the signal strength and/or signal quality of transmissions from the controlling nodes of neighboring cells at said UEs, and maintaining a list of neighboring cells based on such measurement reports, said list showing how many of the UEs in the first cell that each of said neighboring cells “covers”, i.e. reaches with a signal strength and/or quality above a certain level, the method further comprising deciding to perform blind handover or release with redirect of one of the UEs in the first cell, and to choose one or more of the cells in the list as target cell or cells for the blind handover or the release with redirect.

16. The method of claim 15, according to which, in the case of a decision to perform release with redirect on one of the UEs in the first cell, information on said one or more cells in the list is transmitted to the UE.

17. The method of claim 15, according to which said list also comprises system information for the neighboring cells.

18. The method of claim 15, according to which said list is per frequency or frequency group.

19. The method of claim 15, comprising instructing all or a sub-set of the UEs in the first cell to transmit said measurement reports to the controlling node.

20. The method of claim 19, comprising, in the case of a sub-set, choosing the UEs in the sub-set in a random fashion.

21. The method of claim 15, comprising establishing said list based on said measurement reports, and in the case of a sub-set, using the measurement reports to extrapolate how many of the UEs in the first cell that each of said neighboring cells covers, expressed as a percentage.

22. (canceled)

23. The method of claim 15, which, in the case of release with redirect, comprises transmitting instructions to the UE to perform release with redirect to one of the cells in said list without notifying the controlling nodes of the cells in said list that the UE has been instructed to perform release with redirect.

24. The method of claim 15, which, in the case of blind handover, comprises transmitting instructions to perform handover to the UE and notifying the controlling node of said neighboring cell that the UE has been instructed to perform handover.

25. The method of claim 15, comprising establishing said list so that it contains a predetermined number N of neighboring cells, which are the N neighboring cells that have the highest degree of coverage in the first cell.

26. (canceled)

27. The method of claim 15, comprising receiving from another controlling node, directly or via another network node, in the cellular network a corresponding list established by the other controlling node for a cell controlled by the other controlling node, the method comprising the use of said corresponding list when making decisions on blind handover or release with redirect for UEs in its cell.

28. The method of claim 15, also comprising receiving measurement reports from User Equipments, UEs, in the first cell on the signal strength and/or quality of specific frequencies from controlling nodes of neighboring cells at said UEs, and maintaining a list of such frequencies based on measurement reports, said list showing how many of the UEs in the first cell that each of said frequency “covers”, i.e. reaches with a signal strength and/or quality above a certain level, the method also comprising transmitting all or parts of said list to a UE, in the first cell, as well as instructing the UE to perform blind handover or release with redirect to one of the frequencies in said list.
